(19) United States
(12) Patent Application Publication
(10) Pub. No.: US 2014/0205706 A1
(43) Pub. Date: Jul. 24, 2014

(54) MOLDING ROLLER, APPARATUS AND METHOD FOR MANUFACTURING SAME

(71) Applicant: Hon Hai Precision Industry Co., Ltd., New Taipei (TW)

(72) Inventor: CHIA-LING HSU, New Taipei (TW)

(73) Assignee: HON HAI PRECISION INDUSTRY CO., LTD., New Taipei (TW)

(21) Appl. No.: 13/954,011

(22) Filed: Jul. 30, 2013

(30) Foreign Application Priority Data
Jan. 24, 2013 (TW) 102102575

(51) Int. Cl. B30B 3/00; B29D 99/00

(52) U.S. Cl. CPC B30B 3/005; B29D 99/0032
USPC 425/471; 156/446; 156/187

(57) ABSTRACT

A molding roller includes a cylindrical main body and a flexible molding film. The main body has a circumferential surface. The molding film is wound around and fixed to the circumferential surface. The molding film has a molding surface including a number of molding patterns. The molding film is made of polymer resin consisting of polydimethylsiloxane and a plurality of silica nanoparticles in polymer grids of the polydimethylsiloxane.

### BACKGROUND

1. Technical Field

The present disclosure relates to a molding roller, an apparatus and a method for manufacturing the molding roller.

2. Description of Related Art

Optical films include a number of micro structures. One method for forming the micro structures is a roll forming process using a metallic roller. The metallic roller has a circumferential surface including molding patterns for forming the micro structures. The molding pattern is formed by a laser knife. However, it is difficult to machine the molding patterns on a curved surface of the metallic roller, therefore, the machining efficiency is relatively low.

Therefore, it is desirable to provide a molding roller, an apparatus and a method for manufacturing the molding roller that can overcome the above-mentioned limitations.

### BRIEF DESCRIPTION OF THE DRAWINGS

Many aspects of the embodiments should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a molding roller, according to a first exemplary embodiment.

FIG. 2 is a schematic view of an apparatus for manufacturing a molding roller, according to a second exemplary embodiment.

FIG. 3 to FIG. 5 are flowcharts of a method for manufacturing a molding roller, according to a third exemplary embodiment.

### DETAILED DESCRIPTION

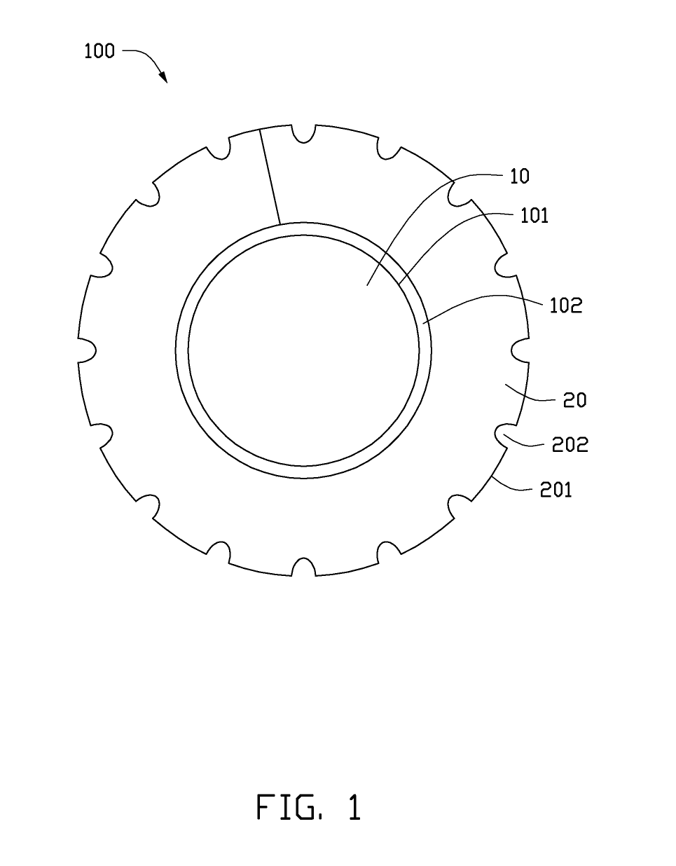

FIG. 1 illustrates a molding roller 100 in accordance with a first exemplary embodiment. The molding roller 100 includes a cylindrical main body 10 and a flexible ring-shaped molding film 20. The main body 10 includes a circumferential surface 101, and can be made of stainless steel or other metals. The circumferential surface 101 is coated with an adhesive glue 102.

The molding film 20 is wound around and fixed to the circumferential surface 101 of the main body 10 via the adhesive glue 102. The molding film 20 includes a molding surface 201 opposite to the main body 10. The molding surface 201 includes a number of molding patterns 202. In the first embodiment, the molding patterns 202 are micro striped grooves. In other embodiments, the molding patterns 202 also can be micro-dots, striped protrusions or micro domes.

The molding film 20 is made of flexible polymer material. The flexible polymer material consists of polymer resin and a number of silica nanoparticles formed in polymer grids of the polymer resin. In the first embodiment, the polymer resin is polydimethylsiloxane (PDMS) resin, and the silica nanoparticles are formed by sol-gel method.

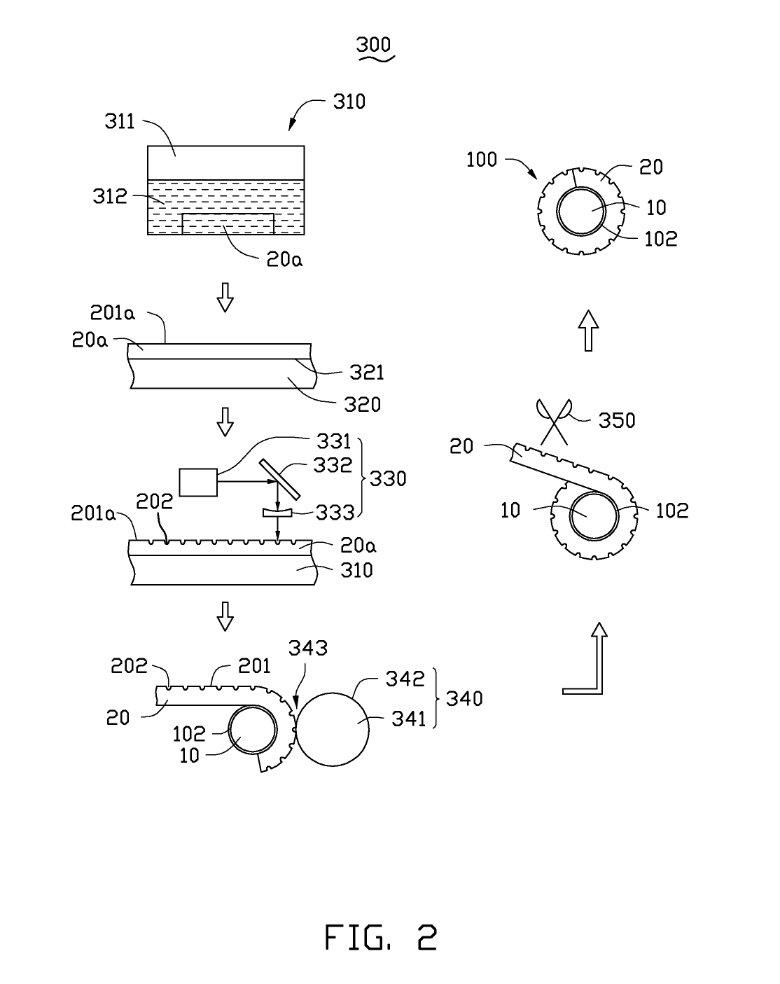

FIG. 2 shows an apparatus 300 for manufacturing the molding roller 100, according to a second exemplary embodiment. The apparatus 300 includes a film chemical treatment device 310, a loading plate 320, a processing device 330, a mounting device 340, and a cutting device 350.

The film chemical treatment device 310 is used for forming the silica nanoparticles in the polymer grids of an original film 20b to form a preprocessed molding film 20a. The film chemical treatment device 310 includes a container 311 for receiving a reaction liquid 312 including of dibutyl tin diacetate (DBTDA) and tetraethoxy silane (TEOS). The original film 20b is immersed in the reaction liquid 312 for a first predetermined period, and thus the reaction liquid 312 penetrates the original film 20b, then the original film 20b is taken out from the container 311, and is placed in the air for a second predetermined period. The DBTDA is hydrolyzed to obtain acetic acid. The acetic acid can accelerate the reaction of TEOS with the original film 20b to form the silica nanoparticles in the polymer grids of the original film 20b.

The loading plate 320 has a planar loading surface 321 for loading the preprocessed molding film 20a. The preprocessed molding film 20a has a planar preprocessed molding surface 201a opposite to the loading plate 320. Two opposite ends of the preprocessed molding film 20a can be fixed to the planar loading surface 321 through an adhesive glue (not shown) or other fixing means.

The processing device 330 is used for forming a number of molding patterns 202 on the preprocessed molding surface 201a, so as to obtain the molding film 20 having the molding surface 201. In the second embodiment, the processing device 330 includes a laser emitter 331, a reflector 332, and a converging lens 333. The laser emitter 331 is used for emitting laser rays. The transmitting direction of the laser rays is substantially parallel to the preprocessed molding surface 201. The reflector 332 is used for changing the transmitting direction of the laser rays and reflecting the laser rays to the converging lens 333. The converging lens 333 converges the laser rays to the preprocessed molding surface 201. In other embodiments, the reflector 332 and the converging lens 333 can be omitted, and the transmitting direction of the laser rays should be substantially perpendicular to the preprocessed molding surface 201. In other embodiments, if the impression patterns 202 are V-shaped grooves, and the processing device 330 can include a diamond knife having a V-shaped blade.

The mounting device 340 is used for mounting the molding film 20 on the circumferential surface 101 of the main body 10, and includes an auxiliary roller 341 having a smooth circumferential surface 342. The auxiliary roller 341 is spaced at a predetermined distance from the main body 10 to form a molding channel 343. The auxiliary roller 341 and the main body 10 are rotated in reverse directions. The circumferential surface 101 is coated with an adhesive glue 102. An end of the molding film 20 is adhered on the circumferential surface 101, then the main body 10 and the auxiliary roller 341 are rotated to make the molding film 20 pass through the molding channel 343, and thus the molding film 20 is wound around and fixed to the circumferential surface 101 via the adhesive glue 102.

The cutting device 350 is used for cutting the molding film 20.

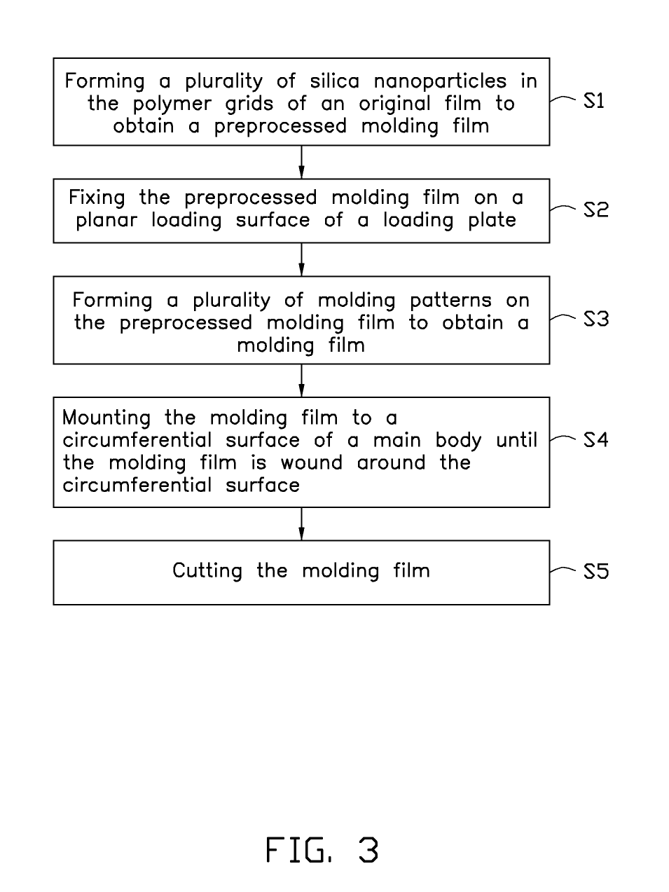

FIG. 3 shows a method for manufacturing the molding roller 100 using the apparatus 300, according to a third exemplary embodiment. The method includes the following steps.

In step S1, the silica nanoparticles are formed in the polymer grids of the original film 20b using the film chemical treatment device 310, and thus the preprocessed molding film 20a is obtained. In the third embodiment, the original film 20b is made of PDMS.

In step S2, the preprocessed molding film 20a is fixed to the planar loading surface 321 of the loading plate 320. The processed molding film 20a has a preprocessed molding surface 201 opposite to the loading plate 320.

In step S3, the molding patterns 202 are formed on the preprocessed molding surface 201a of the preprocessed molding film 20a using the processing device 330, and thus the molding film 20 having the molding surface 201 is obtained. In the third embodiment, the processing device 330 emits laser light to machine the preprocessed molding surface 201a.

In step S4, the molding film 20 is separated from the loading plate 320, the molding film 20 is wound around and fixed to the circumferential surface 101 of the main body 10, and the molding surface 201 is opposite to the circumferential surface 101.

In step S5, the molding film 20 is cut by the cutting device 350.

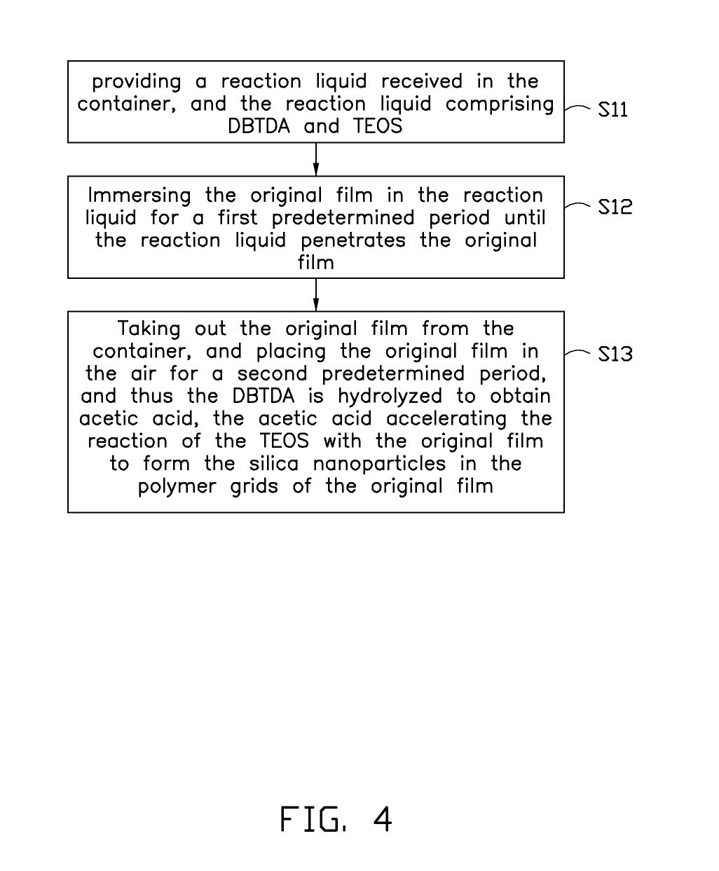

FIG. 4 shows that the step S1 includes the following sub-steps.

In step S11, the reaction liquid 312 is provided and is received in the container 311, and the reaction liquid 312 includes DBTDA and TEOS.

In step S12, the original film 20a is immersed in the reaction liquid 312 for the first predetermined period, and thus the reaction liquid 312 penetrates the original film 20a.

In step S13, the original film 20a is taken out from the container 311, and is placed in the air for the second predetermined period, and thus the DBTDA is hydrolyzed to obtain acetic acid. The acetic acid can accelerate the reaction of the TEOS with the preprocessed molding film 20a to form the silica nanoparticles in the polymer grids of the original film 20a.

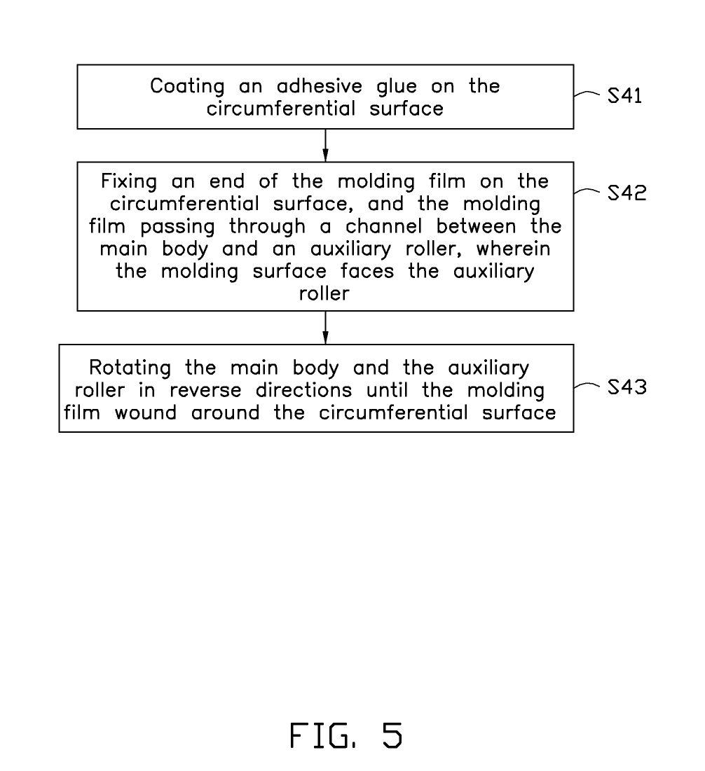

FIG. 5 shows that the step S4 includes the following sub-steps.

In step S41, the circumferential surface 101 is coated with the adhesive glue 102.

In step S42, one end of the molding film 20 is adhered on the circumferential surface 101, and the molding surface 201 faces the auxiliary roller 351.

In step S43, the main body 10 and the auxiliary roller 341 are rotated in reverse directions to make the molding film 20 pass through the molding channel 343 until the molding film 20 is wound around and fixed to the circumferential surface 101.

By employing the apparatus 300 and the above described method, it is easier for the processing device 330 to machine the molding patterns 202 on the planar preprocessed molding surface 201a relative to on a curved surface. Therefore, the machining efficiency is improved.

It will be understood that the above particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A molding roller, comprising:
a cylindrical main body having a circumferential surface; and
a flexible molding film wound around and fixed to the circumferential surface, the molding film having a molding surface opposite to the main body, and the molding surface having a plurality of molding patterns;
wherein the molding film is made of polymer material consisting of polydimethylsiloxane resin and a plurality of silica nanoparticles in polymer grids of the polydimethylsiloxane resin.

2. The molding roller of claim 1, wherein the silica nanoparticles is formed in polymer grids of the polydimethylsiloxane resin by sol-gel method.

3. The molding roller of claim 1, wherein the circumferential surface is coated with an adhesive glue, and the molding film is fixed to the circumferential surface through the adhesive glue.

4. The molding roller of claim 1, wherein the main body is made of metal.

5. An apparatus for manufacturing a molding roller, comprising:
a film chemical treatment device configured for forming a plurality of silica nanoparticles in the polymer grids of an original film to obtain a preprocessed molding film;
a loading plate having a planar loading surface for loading the preprocessed molding film, the preprocessed molding film having a planar preprocessed molding surface opposite to the loading plate;
a processing device configured for forming a plurality of molding patterns on the preprocessed molding surface to obtain a molding film with a molding surface;
a mounting device configured for mounting the molding film to a circumferential surface of a main body until the molding film is wound around the circumferential surface; and
a cutting device configured for cutting the molding film, and the molding film and the main body cooperatively forming the molding roller.

6. The apparatus of claim 5, wherein the film chemical treatment device comprises a container for receiving a reaction liquid, the reaction liquid comprises dibutyl tin diacetate and tetraethoxy silane, when the original film is immersed in the reaction liquid for a first predetermined period, the reaction liquid penetrates the original film, then the original film is taken out from the container, and is placed in the air for a second predetermined period the dibutyl tin diacetate is hydrolyzed to obtain acetic acid, the acetic acid accelerates the reaction of the tetraethoxy silane with the original film to form the silica nanoparticles in the polymer grids of the original film.

7. The apparatus of claim 5, wherein the processing device comprises a laser emitter, a reflector, and a converging lens, the laser emitter emits laser rays, the transmitting direction of the laser rays is substantially parallel to the preprocessed molding surface, the reflector changes the transmitting direction of the laser rays and reflecting the laser rays to the converging lens, the converging lens converges the laser rays to the preprocessed molding surface.

8. The apparatus of claim 5, wherein the mounting device comprises an auxiliary roller spaced a predetermined distance from the main body to form a channel between the auxiliary roller and the main body.

9. A method for manufacturing a molding roller, comprising
forming a plurality of silica nanoparticles in the polymer grids of an original film to obtain a preprocessed molding film;
fixing the preprocessed molding film on a planar loading surface of a loading plate, the preprocessed molding film having a planar preprocessed molding surface opposite to the loading plate;
forming a plurality of molding patterns on the preprocessed molding surface to obtain a molding film having a molding surface;
mounting the molding film to a circumferential surface of a main body until the molding film is wound around the circumferential surface; and
cutting the molding film.

10. The method of claim 9, wherein the step of forming a plurality of silica nanoparticles in the polymer grids of an original film to obtain a preprocessed molding film further comprises:
providing a reaction liquid received in a container, the reaction liquid comprising dibutyl tin diacetate and tetraethoxy silane;
immersing the original film in the reaction liquid for a first predetermined period until the reaction liquid penetrates the original film;
taking out the original film from the container; and
placing the original film in the air for a second predetermined period, such that the dibutyl tin diacetate is hydrolyzed to obtain acetic acid, the acetic acid accelerating the reaction of the tetraethoxy silane with the original film to form the silica nanoparticles in the polymer grids of the original film.

11. The method of claim 9, wherein the step of mounting the molding film on a circumferential surface of a main body further comprises:
coating an adhesive glue on the circumferential surface;
fixing an end of the molding film on the circumferential surface, with the molding film passing through a channel between the main body and an auxiliary roller, wherein the molding surface faces the auxiliary roller; and
rotating the main body and the auxiliary roller in reverse directions until the molding film wound around the circumferential surface of the main body.
